(19) United States
(12) Patent Application Publication
(10) Pub. No.: US 2013/0084025 A1
(43) Pub. Date: Apr. 4, 2013

(54) Method for Brightness Correction of Defective Pixels of Digital Monochrome Image

(71) Applicant: ZAKRYTOE AKCIONERNOE OBSHCHESTVO, Sankt-Petersburg (RU)

(72) Inventor: Ruslan Nikolaevich KOSAREV, Kingisepp (RU)

(73) Assignee: ZAKRYTOE AKCIONERNOE OBSHCHESTVO "IMPUL'S", Sankt-Petersburg (RU)

(21) Appl. No.: 13/632,329

(22) Filed: Oct. 1, 2012

(30) Foreign Application Priority Data
Sep. 30, 2011 (EA) 201101321

(51) Int. Cl. G06K 9/40

(52) U.S. Cl. 382/274

(57) ABSTRACT

A method for brightness correction of defective pixels of digital monochrome image consisting in calculation of defective pixel brightness values over its neighborhood, creation of a defective pixel map that is used to determine a defective cluster perimeter preferably quadruply-connected one and calculate brightness value of each defective pixel belonging to such a perimeter; performing such a procedure iteratively until brightness value of each defective pixel has been calculated; defective pixel brightness value is calculated as an average weighed value over neighboring pixel brightness values. The technical result of the claimed method consists in increased quality of obtained image by means of brightness correction of defective pixels of a digital monochrome image.

### FIELD OF THE INVENTION

This invention relates to image processing methods, namely, to the brightness correction of defective pixels of a digital monochrome image.

### BACKGROUND OF THE INVENTION

Digital imaging detectors contain a great number of similar cells (pixels) some of which or a small group of which can be defective. In images these defects appear as view-dependent areas with lower brightness values than those of neighbouring pixels registering a real signal. Such pixels are called defective pixels; groups of defective pixels are called defective clusters. The most widely-spread defects are as follows.

Dead pixel—this defect results in output signal invariability at different input signal levels.

Hot pixel—this defect results in an incorrect output signal dependence on the input one or it significantly depends on other factors, e.g. temperature or adjacent pixels values.

Dependent pixel—this defect results in pixel signal dependence on adjacent pixel signals.

Input parameters for image correction method are defective pixels coordinates, row and column numbers which are determined at digital detector calibration stage. As a rule, defective pixel brightness value is calculated over adjacent pixels by the use of different calculation techniques. Defective pixel brightness correction contributes to better perception of visualized digital image and simplifies further processing, e.g. during noise reduction, contrast and brightness level calculation, and during object searching in the image etc.

In the present application we claim a brightness correction method of the defective pixels the coordinates of which are determined at the digital detector calibration stage, and are the input parameters for the correction method.

The method [A. Efros and T. Leug. Texture synthesis by non-parametric sampling. Proc. Int. Conf. Computer Vision, pp. 1033-1038, Greece, September 1999] is known. Let i and j be image pixels coordinates, υ(i) and υ(j) brightness values of mentioned pixels, N(i) and N(j) are their neighborhoods. Let a rectangular part of the image with the center in the pixel i be a neighborhood N(i) of pixel i

The known method consists in the fact that when it is necessary to reconstruct signal υ(i), the closest neighborhood N(j) of pixel j over a certain metric d(i, j) is determined using the neighborhood N(i)

j=arg min(d(i, j))

And after the neighborhood N(j) has been determined, signal υ(i) is assumed to be equal to signal υ(j)

υ(ᵢ)=υ(j).

The search of N(j) neighborhood can be conducted over the entire image as well as over any limited image area which is called area to be searched. The metric d(i, j) is calculated in the following manner

$$d ( i , j ) = \frac{1}{Z} {\sum }_{k ∈ N ( i ) , n ∈ N ( j )}^{ } ( 1 - b ( k ) ) \times ( 1 - b ( n ) ) \times {( υ ( k ) - υ ( n ) )}^{2}$$

where b(k) is a binary mask of an appropriate neighborhood: b(k)=0 , if the signal of k pixel is already known, and b(k)=1, if the calculation of the signal of k pixel is still in progress. Normalizing factor Z is

$$Z = {\sum }_{k ∈ N ( i ) , n ∈ N ( j )}^{ } ( 1 - b ( k ) ) \times ( 1 - b ( n ) )$$

Disadvantages of the known method are as follows.

The method is unstable, e.g. if neighborhoods N(j) and N(\tilde{j}) are equally close to the N(i)neighborhood and, υ(j) and υ(\tilde{j}) pixel signals differ from each other distinctly.

In the method, reconstructed υ(i) pixel signal is always equal to a certain υ(j) pixel signal from the area to be searched, i.e. the effect of illumination change is not reproduced.

### SUMMARY OF THE INVENTION

The task of the invention is to correct brightness of defective pixels of a digital monochrome image.

The technical result of the claimed method consists in increased quality of the obtained image by means of brightness correction of defective pixels of a digital monochrome image.

The technical result is achieved through the fact that in the method of brightness correction of defective pixels of a digital monochrome image wherein brightness values of defective pixels are calculated using its neighborhood, according to the invention by means of defective pixels mapping a defective clusters perimeter is determined After that the brightness values of each defective pixel within that perimeter is calculated; this procedure is conducted iteratively until brightness value of each defective pixel has been calculated wherein defective pixel brightness value is calculated as an average weighed value over neighboring pixel brightness values.

In order to improve image quality a quadruply-connected perimeter is used as a defective clusters perimeter.

In order to improve image quality the brightness value of defective pixel is determined in accordance with Nadaraya-Watson estimates, performing summation over the area to be searched,

$$υ ( i ) = \frac{{\sum }_{j}^{ } ω ( i , j ) \times υ ( j )}{{\sum }_{j}^{ } ω ( i , j )}$$

i, j are pixel indices;

N(i) is a neighborhood value of i-th pixel;

υ(i) is a brightness value under determination of the i-th defective pixel;

υ(j) is a brightness value of the j-th pixel;

ω(i, j) weighs calculated using the formula

$$ω ( i , j ) = ( 1 - b ( j ) ) \times exp ( - \frac{d ( i , j )}{{h}^{2}} )$$

h is a smoothing parameter;

N(j)

d (i,j) is a distance between neighborhoods N(i) and N(j)

$$d ( i , j ) = \frac{1}{Z ( i , j )} {\sum }_{k ∈ N ( i ) , n ∈ N ( j )}^{ } ( 1 - b ( k ) ) \times ( 1 - b ( n ) ) \times {( υ ( k ) - υ ( n ) )}^{2}$$

k, n are pixel indices;

Z (i, j) is a normalizing factor

$$Z ( i , j ) = {\sum }_{k ∈ N ( i ) , n ∈ N ( j )}^{ } ( 1 - b ( k ) ) \times ( 1 - b ( n ) )$$

b(k) and b(n) are values of k-th and n-th pixels in the defective pixel map.

In order to improve image quality and to shorten claimed method software run time the defective pixels perimeter is classified over 3×3 neighbouring pixels, and in order to correct brightness of defective pixels belonging to different classes, different values of neighborhood sizes and areas to be searched are used, at that the following classification and values of neighborhood sizes and area to be searched are used:

clusters with defective pixel quantity less than three, 3×3 pixels neighborhood sizes and 3×3 pixels area to be searched;

clusters with defective pixel quantity four or more, 5×5 pixels neighborhood sizes and 5×5 pixels area be searched;

defective clusters in the shape of a row with one pixel width, 5×5 pixels neighborhood sizes and 3×7 pixels area be searched for a row and 7×3 pixels - for a column;

defective clusters in the shape of a row with two pixels in width, 5×5 pixels neighborhood sizes and 5×7 pixels area be searched for a row and 7×5 pixels - for a column

Peculiarity of the claimed method is as follows.

The method does not depend on defective pixel geometry, i. g. it allows brightness values of defective clusters of any shape to be corrected without any limits

The method realistically reconstructs image texture, for instance, signal at the border of abrupt change of brightness and in the area of local periodic textures.

In order to provide independence of the claimed method on defective cluster geometry the defective pixel correction procedure is performed iteratively—over defective cluster perimeter. Firstly, a defective pixel map is plotted using specified defective pixel coordinates—binary image in which defective pixels are denoted by units, while pixels with real signal—by noughts. A quadruply-connected perimeter is found in the defective pixel map and brightness value of each defective pixel belonging to the perimeter is calculated, after that pixels with corrected brightness are denoted by noughts in the defective pixel map. Further, this procedure continues until brightness value of the last defective pixel has been calculated. A defective cluster perimeter was calculated by means of well-known Look Up table (LUT) method [Gonzalez R., Woods R., Steven L. Eddins. Digital Image Processing using MATLAB. Technosphera, 2006, p. 370].

The essence of correction method of defective pixel brightness is that defective pixel brightness value is calculated as a weighed mean over neighbouring pixels brightness. At that defective pixel neighborhood is considered a regressor and defective pixel brightness value—a dependent variable (the terms of regression analysis are used here). For calculation of defective pixel brightness value that is a dependent variable we use Nadaraya-Watson's estimates from Nonparametric regression method [A. W. Bowman and A. Azzalini, Applied Smoothing Techniques for Data Analysis, Clarendon Press, 1997, p. 49]

$$y = \frac{\sum {y}_{i} \times K ( \frac{‖ {x}_{i} - x ‖}{h} )}{\sum K ( \frac{‖ {x}_{i} - x ‖}{h} )}$$

where K(·) is a kernel smoother, h is a smoothing parameter (width of the window). In this case x denotes a defective pixel neighborhood and y is calculated defective pixel brightness value.

### BRIEF DESCRIPTION OF THE DRAWINGS

The implementation of the correction method of defective pixel brightness is illustrated by FIGS. 1-6.

FIG. 1 shows defective cluster perimeter of 10×10 pixels in size. Defective pixels being in white are denoted by 1. Pixels with real signal being in grey are denoted by 2.

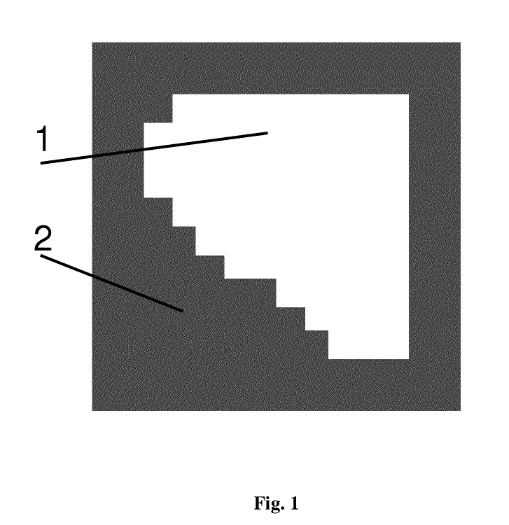

FIG. 2 shows a quadruply-connected perimeter of the defective cluster shown in FIG. 1. In white color and by digit 3 are denoted those pixels which form a quadruply-connected cluster perimeter of defective pixels. One of the perimeter defective pixels is 4, its 3×3 pixel neighborhood is 5.

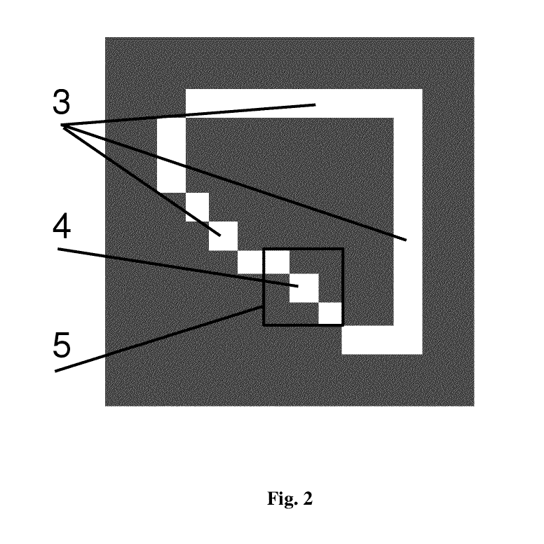

FIG. 3 shows an example of a part of the image containing defective pixels. Defective columns and rows of one pixel in width are 6. Defective columns and rows of two pixels in width are 7. Columns one pixel in width containing defects of dash-dot line type are 8.

FIG. 4 shows an example of a part of the image containing defective pixels. Defective row of one pixel in width is 6. Defective columns and rows of two pixels in width are 7.

FIG. 5 shows the image presented in FIG. 3 after correction.

FIG. 6 shows the image presented in FIG. 4 after correction.

### DETAILED DESCRIPTION OF THE PREFERRED EMBODIMENTS

In the claimed method brightness value v (i) of the defective pixel i is calculated as an average weighed value

$$υ ( i ) = \frac{{\sum }_{j}^{ } ω ( i , j ) \times υ ( j )}{{\sum }_{j}^{ } ω ( i , j )}$$

where Ω(i, j) is weighting factors with common limit 0≦Ω(i, j)≦1 and the term of fraction are normalization conditions. Summation in the above formula is performed over given area to be searched. Let N(i) and N(j) mean mentioned above pixel neighborhood with i and j coordinates. Let us calculate a distance between these neighborhoods

$$d ( i , j ) = \frac{1}{Z ( i , j )} {\sum }_{k ∈ N ( i ) , n ∈ N ( j )}^{ } ( 1 - b ( k ) ) \times ( 1 - b ( n ) ) \times {( υ ( k ) - υ ( n ) )}^{2}$$

where b(k)=1, if the pixel is marked as defective one, and b(k)=0 otherwise. The normalizing factor Z(i, j) is

$$Z ( i , j ) = {\sum }_{k ∈ N ( i ) , n ∈ N ( j )}^{ } ( 1 - b ( k ) ) \times ( 1 - b ( n ) )$$

Weights Ω(i, j) are calculated using the formula

$$ω ( i , j ) = ( 1 - b ( j ) ) \times exp ( - \frac{d ( i , j )}{{h}^{2}} )$$

The smoothing parameter h is selected being proportional to a smoothing perimeter that is calculated according to Silverman's Rule [A. W. Bowman and A. Azzalini, Applied Smoothing Techniques for Data Analysis, Clarendon Press, 1997, p. 31]

$$h = k \times {( \frac{4}{3 m} )}^{1 / 5} \times {σ}_{d}$$

The dimensionless factor k is a parameter of the claimed correction method and is introduced to provide regulation of the smoothing parameter h.

Parameters of the claimed correction method of defective pixel brightness are:

Vertical and horizontal sizes of defective pixel neighborhood.

Vertical and horizontal sizes of area to search.

Dimensionless factor k.

### PREFERABLE VARIANT OF THE INVENTION EMBODIMENT

Computational complexity of the claimed method of correction of defective pixel brightness is high enough. The first possibility to accelerate the algorithm without any change in the calculation method is to optimize algorithm parameters in relation to defect geometry. In the claimed method the following classification of defective clusters in 3×3 pixel neighborhood is used.

Small cluster is a cluster containing 3 defective pixels or less.

Large cluster is a cluster containing 4 defective pixels or more.

Defective cluster as a row of one pixel in width.

Defective cluster as a row of two pixels in width.

For a particular digital detector number of defective clusters of which does not exceed 7×7 pixels and the width of a defective row is no more than two pixels, the following algorithm parameters can be used (see Table).

TABLE

| | | Neighborhood | Dimensions of the |
|---|---|---|---|
| | | dimensions | area to be searched |
| | | (vertical and | (vertical and |
| Cluster | Definition | horizontal) | horizontal) |
| Small | number of defective | 3 × 3 | 3 × 3 |
| cluster | clusters is three or less | | |
| Large | number of defective | 5 × 5 | 5 × 5 |
| cluster | clusters is four or more | | |
| Row | defective cluster of a | 5 × 5 | 3 × 7 |
| | row type | | |
| | defective cluster of a | 5 × 5 | 7 × 3 |
| | column type | | |
| Double | defective cluster of a | 5 × 5 | 5 × 7 |
| row | double row type | | |
| | defective cluster of a | 5 × 5 | 7 × 5 |
| | double column type | | |

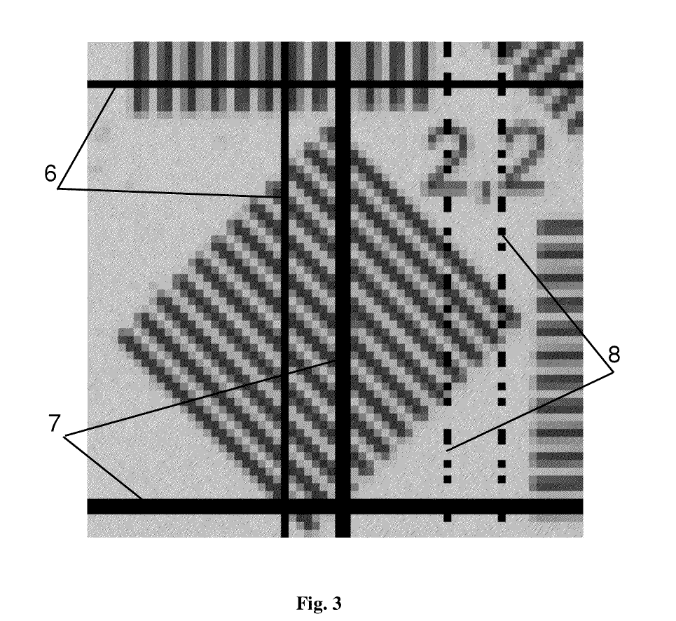

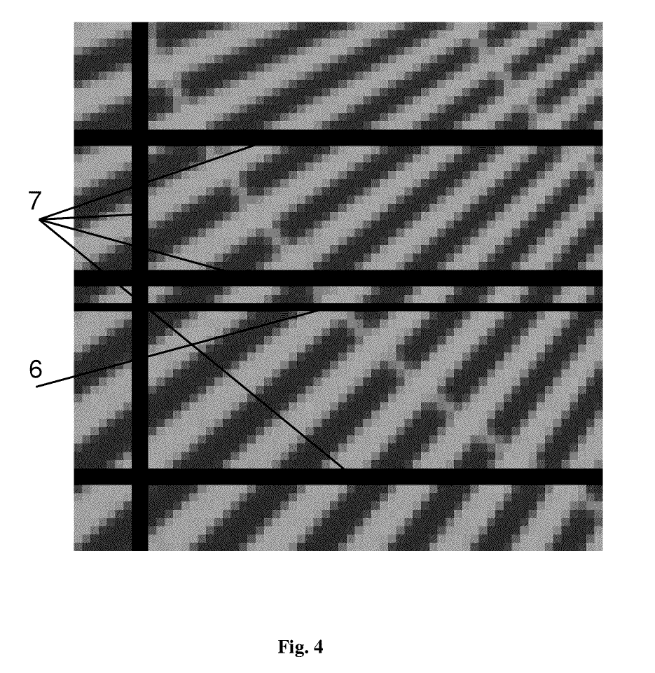

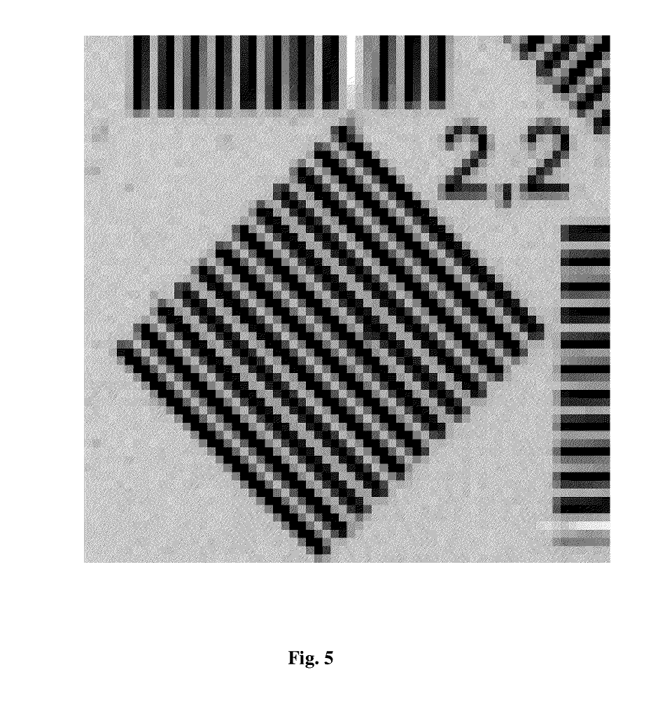

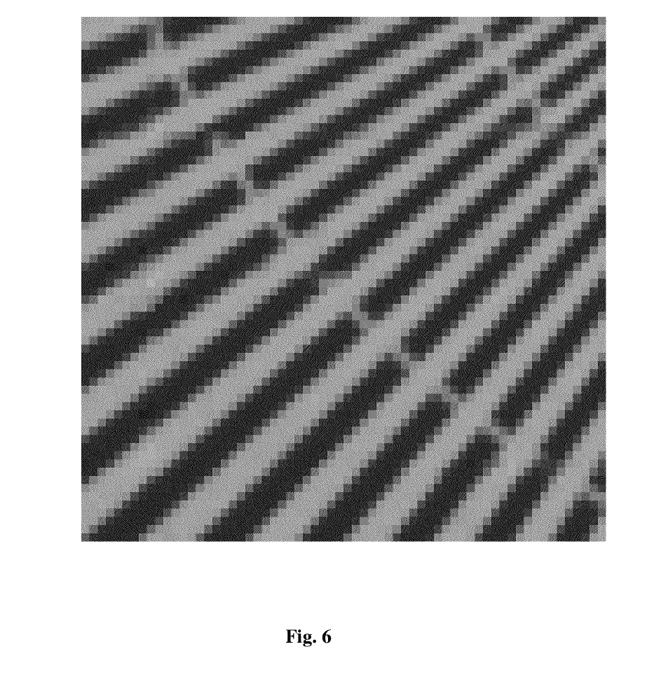

In the examples of correction of defective pixel brightness the parameters given in the table were used, k factor is 1. FIGS. 3 and 4 show examples of images with defects in form of row-and columns of width one and two pixels, and columns of one pixel in width containing defects of dash-dot line type. FIGS. 5 and 6 show the same images but after the correction by means of the claimed method.

What is claimed is:

1. A method for correcting brightness of defective pixels of a digital monochrome image, the method comprising:
constructing a map of defective pixels and using it to determine to determine a perimeter of defective clusters;
calculating the brightness of each defective pixel from the perimeter, the brightness of each defective pixel being calculated as an average weighted value over brightness values of neighboring pixels; and
repeating the calculating step by iteration until the brightness of all defective pixels.

2. The method as claimed in claim 1, wherein the perimeter is a quadruply-connected perimeter.

3. The method as claimed in claim 2, wherein the brightness of each defective pixel is determined using a Nadaraya-Watson estimate by performing summation over a search area as:
$$υ ( i ) = \frac{{\sum }_{j }^{ } ω ( i , j ) \times υ ( j )}{{\sum }_{j}^{ } ω ( i , j )}$$
i, j are pixel indices;
N(i) is a neighborhood value of i-th pixel;
υ(i) is a calculated brightness value of the i-th defective pixel;
υ(j) is a brightness value of the j-th pixel;
Ω(i, j) weighs.

4. The method of claim 3, wherein Ω(i, j) is calculated as:
$$ω ( i , j ) = ( 1 - b ( j ) ) \times exp ( - \frac{d ( i , j )}{{h}^{2}} )$$
h is a smoothing parameter;
d (i, j) is a distance between neighborhoods N(i) and N(j)
$$d ( i , j ) = \frac{1}{Z ( i , j )} {\sum }_{k ∈ N ( i ) , n ∈ N ( j )}^{ } ( 1 - b ( k ) ) \times ( 1 - b ( n ) ) \times {( υ ( k ) - υ ( n ) )}^{2}$$
k, n are pixel indices;
Z(i, j) is a normalizing factor
$$Z ( i , j ) = {\sum }_{k ∈ N ( i ) , n ∈ N ( j )}^{ } ( 1 - b ( k ) ) \times ( 1 - b ( n ) )$$
b(k) and b(n) are values of k-th and n-th pixels in the map of defective pixels.

5. The method as claimed in claim 3, further comprising:
classifying each defective pixel of the perimeter are classified in relation to its 3×3 pixel neighborhood;
utilizing different neighborhoods and different search areas to correct the brightness of defective pixels of different classes, wherein the following classification and size of neighborhood values and the search area are used:
clusters having three or fewer defective pixels, 3×3 pixel neighborhood size and 3×3 pixel search area;
clusters having four or more defective pixels, 5×5 pixel neighborhood size and 5×5 pixel search area;
a row of the defective clusters having a width of one pixel, 5×5 pixel neighborhood size, and 3×7 pixel search area for a row and 7×3 pixel search area for a column;
a row of the defective clusters having a width of two pixels, 5×5 pixel neighborhood size, and 5×7 pixel search area for a row and 7×5 pixel search area for a column.
